(19) United States
(12) Patent Application Publication
(10) Pub. No.: US 2015/0149884 A1
(43) Pub. Date: May 28, 2015

(54) DISTRIBUTED COMPUTING ENVIRONMENT BASED DOCUMENT PERSONALIZER

(71) Applicants: DIRK WAGNER, Marpingen (DE); Joerg Steinmann, Voelklingen (DE); Christoph Birkenhauer, Wiesloch (DE)

(72) Inventors: DIRK WAGNER, Marpingen (DE); Joerg Steinmann, Voelklingen (DE); Christoph Birkenhauer, Wiesloch (DE)

(21) Appl. No.: 14/086,969

(22) Filed: Nov. 22, 2013

(51) Int. Cl. G06F 17/22

(52) U.S. Cl. CPC G06F 17/2247
USPC 715/234

(57) ABSTRACT

To generate a personalized electronic document, a cloud-based document personalization application establishes connection with a data store and retrieves an electronic document. The document personalization application parses the retrieved electronic document to determine placeholders, and attributes. The attributes correspond to personalization data. A relation between the attributes and corresponding attribute values is determined. Based on the determination, the attributes in the electronic document are supplanted with the corresponding attribute values. The supplanting of attributes with the corresponding attribute values generates a personalized electronic document.

### BACKGROUND

Customer service is vital for the development of an enterprise. An important part of customer service includes understanding and catering to customers' individual needs and preferences. Personalized customer services may he important not only for retaining current customers with established relationships, but also in attracting new customers. For example, a customer or potential customer may prefer to be addressed in marketing letters by name rather than a generic salutation “Dear Customer” Personalizing the marketing and other letters may be very time consuming and challenging task for enterprises with large number of customers, as such letters or messages may have to be individually drafted, specifically for individual customers.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a distributed computing environment, according to an embodiment.

FIG. 2 is a block diagram illustrating a system for generating a personalized electronic document, according to an embodiment.

FIG. 3 is a block diagram illustrating a system for generating a personalized electronic document, according an embodiment.

FIG. 4 is a flow diagram illustrating a process for generating a personalized electronic document, according to an embodiment.

FIG. 5 is a block diagram of a computer system, according to an embodiment.

### DETAILED DESCRIPTION

Embodiments of distributed computing environment based document personalizer are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily referring to the same embodiment. Furthermore, the particular features, structures, or characteristics may be combined in any suitable manner in one or more embodiments.

An electronic document may be personalized by including personal data corresponding to a customer. Such personalization may be based on factors/properties associated with the electronic document. The properties corresponding to personal data associated with the customer may include a name, a place of residence, a designation, an employer of the customer, etc. Such properties may also include preference of information, preference of language for communication, etc.

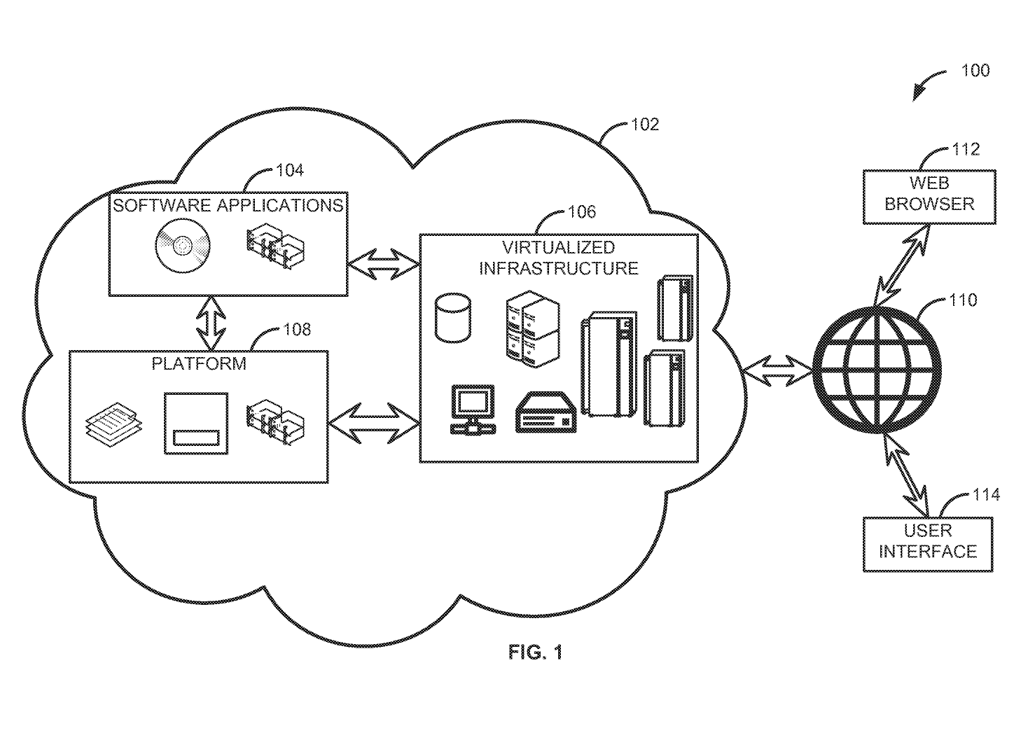

FIG. 1 is a block diagram illustrating distributed computing environment 100, according to an embodiment. Distributed computing environment 100 may include computing resources, such as servers, storage devices, computers, networking devices, central processing unit, random access memory, etc. The computing resources may be interconnected over a real-time communication network. In an embodiment, distributed computing environment 100 may include cloud computing environment 102 or cloud-based environment 102. Cloud computing environment 102 may provide means to run programs and applications simultaneously on multiple computers deployed therein. Such computers could be remotely deployed at different locations and may be accessed over communication network. Cloud computing environment 102 may provide accessibility to such remotely deployed computing resources on demand.

In an embodiment, cloud computing environment 102 may be configured to provide software applications 104 or virtualized infrastructure 106 or platform 108 as a service. Virtualized infrastructure 106 may include platform specific application program interfaces (APIs). Provisioning of resources enables enterprises to utilize the computing resources on-demand, and accomplish desired business objectives. A service provider, hereinafter referred to as a cloud service provider (CSP) may create such a cloud computing environment 102. For instance, the CSP may collaborate with enterprises that provide hardware resources and software resources to establish such cloud-based computing environment 102 and provision such cloud-based computing environment 102 as a service. An end user may procure the services offered by the CSP depending on the business needs.

In an embodiment, the CSP may provision virtualized infrastructure 106 and provide virtualized infrastructure 106 as a service via cloud computing environment 102. Virtualized infrastructure 106 increases flexibility by decoupling operating systems, applications, and services from a specific physical hardware platform. Virtualized infrastructure 106 provides means for establishing multiple virtual environments on a shared hardware platform. Such establishments may include interconnection of data centers, physical servers, physical storage devices, physical networking devices, etc. An enterprise or end user may procure the service offered by the CSP and use such virtualized infrastructure 106 on-demand to achieve the desired business objectives.

In an embodiment, the CSP may provision platform 108 and offer platform 108 as a service via cloud computing environment 102. Platform 108 may refer to a collection of applications programs, software routines, application program interfaces and associated software libraries that implement a common functionality. Platform 108 may be proprietary platform developed by the CSP to support different business objectives of enterprises. In an embodiment, the CSP may provision software applications 104 to be offered as a service via cloud computing environment 102. Software applications 104 may include licensed software applications, or freeware software applications that may be procured from different software vendors. The CSP may customize such software applications 104 and provision software applications 104 as a service based on user needs. The CSP may provision software applications 104 via APIs that may be accessed via a web browser or a user interface associated with software application 104, in an embodiment, the services offered via cloud computing environment 102 may be accessed over network 110, for example, the Internet, using web browsers 112 and user interfaces 114.

In an embodiment, the provisioning of software applications 104, and/or virtualized infrastructure 106, and/or platform 108 via cloud computing environment 102 may be scaled on demand. Scaling on demand or scalability may refer to providing and supporting multidimensional growth in computing resources. Such scalability enables flexible adaptation to accommodate a demand for computing resources in real time. Hence cloud computing environment 102 may provide scalable, adaptable, performance optimized computing environment that is capable of provisioning the computing resources in real time.

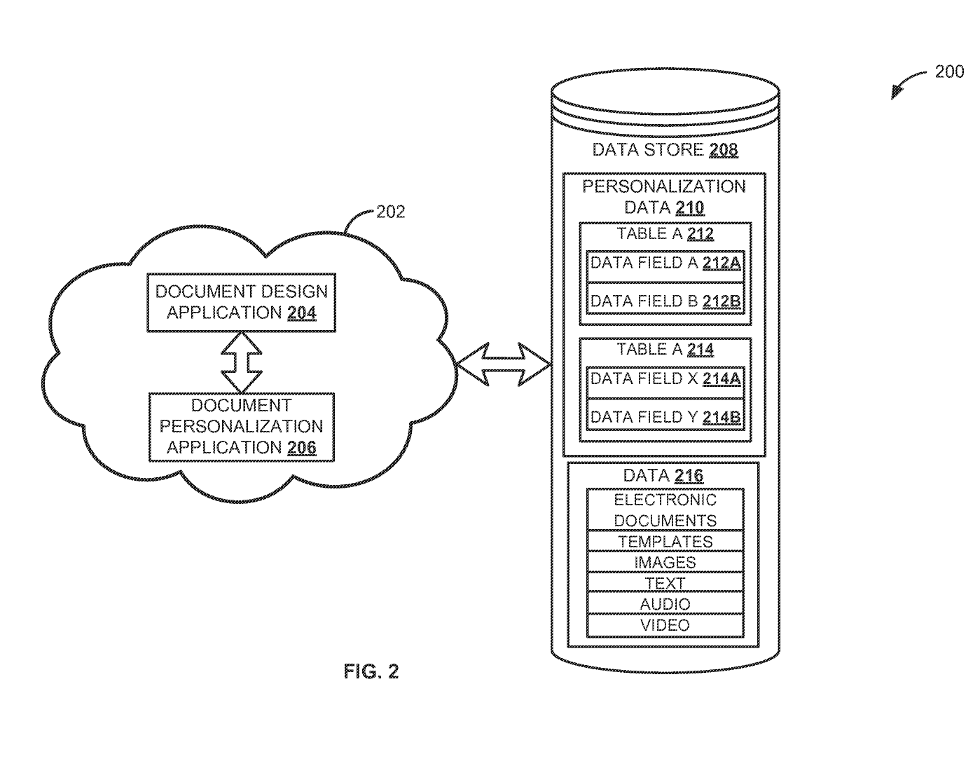

FIG. 2 is a block diagram illustrating system 200 for generating a personalized electronic document, according to an embodiment. In an embodiment, block diagram 200 includes document design application 204, document personalization application 206 and data store 208. Document design application 204 and document personalization application 206 are communicatively coupled with data store 208. Document design application 204 and document personalization application 206 may be configured to work in conjunction with each other. Document design application 204 and document personalization application 206 may be deployed in a distributed computing environment, e.g., in cloud computing environment 202.

In an embodiment, data store 208 stores data 216, such as electronic documents, templates, static and dynamic digital content, such as multimedia, animations, background designs, logos, videos, text, images, etc.; data structures including personal data related to customers, etc. For example, the data structures may correspond to flat files, tables 212, 214 etc. Personal data related to the customers, also referred to as personalization data 210 may include a first name, a last name, an employer name, a job title, name and/or description of a department with which the customer is employed, preference information including a preferred language for communication, etc. In an embodiment, the personal data related to the customers may reside in multiple tables in data store 208. Personalization data 210 may reside in data fields 212A, 212B, 214A, and 214B of tables 212, and 214 respectively, and may be associated with attributes and attribute values. The attribute values may be referenced via objects. Objects may refer to data structures that may reside in the memory, and represent an instance of attribute values and may be referenced by an identifier. For example, a first instance of an object with an identifier OBJ 1 may include values ‘John,’ ‘Smith,’ ‘Manager,’ ‘Sales,’ and ‘SAP.’ A second instance of the object with an identifier OBJ 2 may include values ‘Dwayne’, ‘Bravo’, ‘Supervisor’, ‘Marketing’ and ‘Wal-Mart’ and so on.

In an embodiment, document design application 204 may provide tools to create Hyper Text Markup Language (HTML) documents. For example, HTML documents may include templates for newsletters, mail templates, etc. Document design application 204 may be used to design a mail template including layouts, data fields, etc., to embed content therein. The content may include standard content that is embedded during the design time of the mail template, and may also include attributes that may be replaced with corresponding attribute values. Such replacement of the attributes with attribute values during runtime personalizes the mail template.

In an embodiment, document personalization application 206 may personalize the mail template at runtime. Document personalization application 206 may be configured to determine the layouts, the data fields, the attributes, the standard content, etc. in the mail template. Upon such determination, document personalization application 206 may be configured to supplant the attributes with attribute values corresponding to personalization data 210. Supplanting may herein refer to substitution or replacement. Hence document personalization application 206 personalizes the mail template with corresponding attribute values of personalization data 210 to generate a personalized mail.

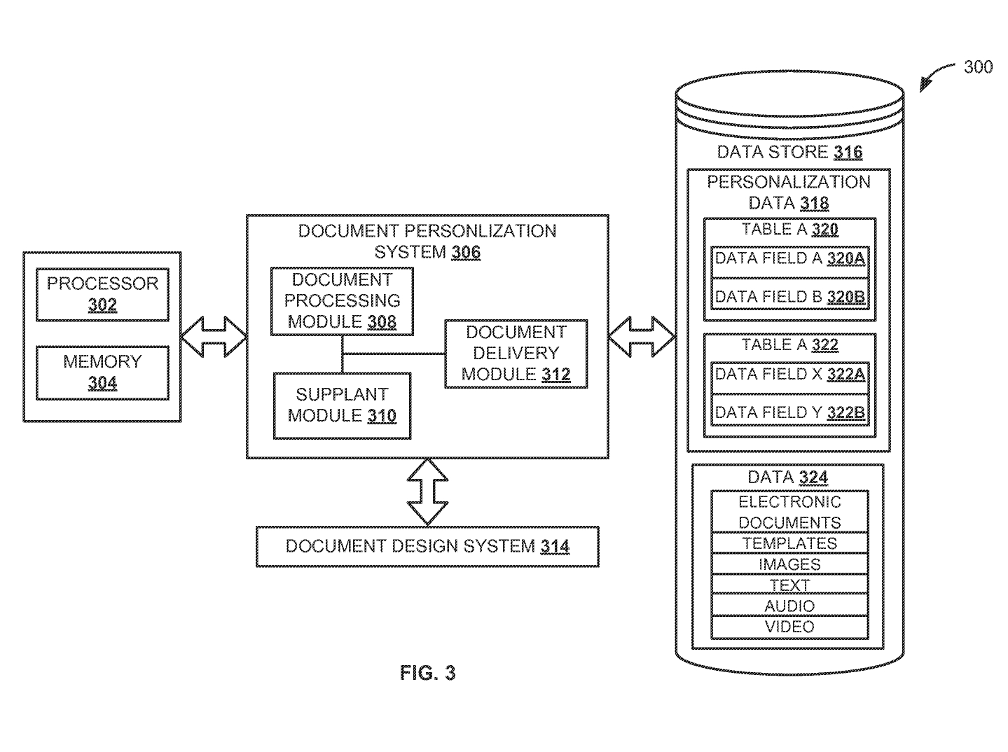

FIG. 3 is a block diagram illustrating system 300 for generating a personalized electronic document, according to an embodiment. In an embodiment, system 300 includes document design system 314, document personalization system 306 and data store 316. Document design system 314 and document personalization system 306 may be configured to work in conjunction with the each other. Document personalization system 306 includes document processing module 308, supplant module 310 and document delivery module 312 communicatively coupled with each other. In an embodiment, memory 304 stores one or more instructions that are configured to be executed by processor 302, to generate the personalized electronic document. Document personalization system 306 may be communicatively coupled with data store 316 over a network (not shown).

In an embodiment, data store 316 may refer to an in-memory database, an operational data store, a conventional database, etc., containing structured and unstructured data. Data 324 residing in data store 316 may include electronic documents, templates, static and dynamic digital content, such as, multimedia, animations, background designs, logos, videos, text, images, etc., personalization data 318 related to customers, etc. For example, the electronic documents may include presentations, spreadsheets, mail form templates, newsletter templates, and the like. The personal data related to the customers, also referred to as personalization data 318 may include a first name, a last name, an employer name, a job title, name and/or description of a department with which the customer is employed, preferred language for communication, etc. Personalization data 318 corresponding to a customer may reside in data fields 320A, 320B, 322A, and 322B of tables 320 and 322 respectively. The personalization data 318 may be referenced by object instances that represent values associated with attributes. The actual values of the attributes, herein referred to as attribute values, may correspond to the values associated with personalization data 318. For example, the attribute values corresponding to the attributes ‘first name’, ‘last name’, ‘employer name’, ‘job title’, ‘name of the department’ with which customer is employed, ‘preferred language’ of communication, etc. may respectively include ‘John,’ ‘Smith,’ ‘SAP,’ ‘Marketing Manager,’ ‘Marketing and Communications,’ ‘English,’ etc.

In an embodiment, document design system 314 may be deployed in cloud computing environment 102 or an on-premise computing environment. When deployed in the on-premise computing environment, document design system 314 may be configured to communicate with other systems and applications in cloud computing environment 102. Document design system 314 may include APIs that provide tools to create HTML documents. For example, HTML documents may include templates for newsletters, mail templates, etc. Document design system 314 may provide design tools and means to include object, a variety of shapes to define layouts, data fields, etc. for embedding content. For example, the content may correspond to HTML content, plain-text content, subject line content, images, special characters and fonts, an editable content, a standard content, etc. For example, a designed document, e.g., mail template may be saved in the data store 316 as data 324. The data fields in the mail template may include placeholders and attributes that may be modified during system 300 runtime. Embedding such data fields in the mail template provides extensibility of reusing the elements of data during run time. In an embodiment, the mail template may embed content based on the customers' preferred language for communication. By default, the preferred language for communication may be configured, for example, to ‘English.’

In an embodiment, document delivery module 312 of document personalization system 306 may be configured to establish connection with data store 316 and retrieve the mail template from data store 316. The retrieved mail template is loaded into document personalization system 306.

In an embodiment, upon loading the mail template, document processing module 308 parses the mail template. Parsing may refer to a process of reading the mail template to analyze the structure and content of the mail template. In an embodiment, parsing may include checking for anomalies. The anomalies may include errors in the mail template, presence of computer contaminants, etc. The errors may correspond to an invalid HTML code, inclusion of incorrect placeholders, etc. The computer contaminants may correspond to viruses, malware, spyware and the like. In an embodiment, upon detecting the anomalies in the mail template, the uploaded mail template may be discarded and a new mail template may be loaded.

Document parsing module 308 parses the mail template to determine placeholders, objects and attributes. Upon such checking and determination, document processing module 308 may instantiate supplant module 310. Upon instantiation, supplant module 310 determines the placeholders, and a relation between the attributes and the associated attribute values. Establishing such correspondences or relations between the attributes and associated attribute values may also be referred as data binding. For example, a placeholder may correspond to an object BOBJ 1; BOBJ 1 may have attributes, such as first name, last name, job title, department, and a place of residence; the corresponding attribute values may be, for example, ‘John’, ‘Smith’, ‘Manager’, ‘Sales’, ‘Austin.’

In an embodiment, based on such determination, supplant module 310 is configured to supplant the attributes with the corresponding attribute values. Such supplanting of the attributes with the attribute values may also be referred to as data merging. Since the attribute values correspond to personalization data 318, the supplanting of the attributes with the corresponding attribute values personalizes the mail template. In an embodiment, supplant module 310 may also be configured to determine layouts corresponding to the standard content, the editable content etc.

In an embodiment, supplant module 310 may be configured to execute one or more rules. The rules may enforce constraints for embedding supplementary content in the personalized mail. For example, a customer may register personal information with a cell phone manufacturer and subscribe to receive updates on release of new cell phone models. To enhance sales and attract more customers, the cell phone manufacturer may collaborate with cell phone service providers. Such collaboration allows the cell phone manufacturer to procure information related to data plans and service plans offered by the cell phone service provider. The procured information may be stored in data store 316, e.g., of the cell phone manufacturer. The data store 316 may also include information related to accessories and support/maintenance services offered with the cell phones. In an embodiment, supplant module 310 may be configured with rules to determine such associated information. Upon such determination, supplant module 310 executes the rules to include such associated information as supplementary content in the personalized mil. For instance, upon execution of the rule, supplant module 310 may embed information related to data plans and service plans offered by cell phone service providers in the personalized mail and send the personalized mail including the supplementary content to the customer.

In an embodiment, document delivery module 312 of document personalization system 306 may be configured to perform a test-send of the personalized mail. For instance, the execution of the test-send may instantiate document delivery module 312 to connect with an e-mail server and send the personalized mail to a predetermined recipient e-mail address.

In an embodiment, document personalization system 306 may prompt a user to manually enter content into the subject line of the personalized mil before the execution of test-send. Such personalization of mails may be used to execute marketing campaigns by sending out e-mails to a large number of customers simultaneously. For example, document personalization system 306 may be configured to send e-mails to a large number of customers as a part of a marketing campaign. The marketing campaign may correspond to disseminating information related to a product or a service offered by an enterprise. As explained above (e.g. description of FIG. 3), document personalization system 306 may be used to personalize electronic documents (e.g. by mail templates) to generate personalized mails including personalized content. Such personalized mails may be embedded in the body of an e-mail and sent to current customers and prospective customers to achieve a desired objective of the marketing campaign.

In an embodiment, document personalization system 306 may embed an e-mail address as a part of the standard content in the personalized mail. The appended e-mail address may be used to unsubscribe from future marketing campaigns. A customer may click on this e-mail address and send a blank e-mail to express their intent to unsubscribe from future marketing campaigns or discontinue from receiving such information.

In an embodiment, document design system 314 may include an application to design mail template using HTML tags. The mail template may include placeholders and attributes that are modified or replaced with attribute value corresponding to personalization data 318. The content of mail template may be encoded. For example, Universal Character Set Transformation Format 8-bit (UTF-8) may be used to encode the content of the mail template. The placeholders may also represent attributes that may include elements such as structure elements, table elements, anchor tags, etc.

In an embodiment, the structure elements may be used to structure the content in the mail template. The table elements may be used to create or define tables. The anchor lags may define hyperlinks to other pages. The placeholders may represent elements of a Form Message Type. The elements of Form Message Type may be replaced or substituted with the corresponding content. In an embodiment, the Form Message Type may be enhanced by extending the placeholders as extension data fields. The mail template may be configured to include such extension data fields. The extension data fields may be associated with user defined attributes and attribute values. The inclusion of extension data fields in the mail template provides extensibility and eliminates the need to write additional software code for retrieving attribute values. The user defined attributes associated with the extension data fields may be supplanted with the corresponding attribute values.

In an embodiment, the general syntax for structure elements may include HTML tags defined, for example, as:

<span class=“variable”>
/<ES name Data Type>/<ES name of element>
</span>

More specifically, an example for structure elements may include:

```
<span class=“variable”>
  /FormTextTemplateTestForm/Account/FormattedName
</span>
<span class=“variable”>
  /FormTextTemplateTestForm/ContactPerson/Title
</span>
```

In an embodiment, the general syntax for table elements may include HTML tags defined, for example, as:

<span class=“variable”>
/<ES name Data Type>/<ES name of table>[<line number>]/<ES name
of element>
</span>

More specifically, an example for table elements may include:

```
<span class=“variable”>
  /FormTextTemplateTestForm/Product[2]/ProductID
</span>
<span class=“variable”>
  /FormTextTemplateTestForm/Product[2]/ProductDescription
</span>
```

In an embodiment, the general syntax for anchor tags may include HTML tags define by:

<a href=“mailto: {/<ES name Data Type>/<ES name of element>}”>
any text
</a>

More specifically, an example for anchor tags may include:

<a
href=“mailto:{/FormTextTemplateTestForm/UnsubscribeMailToName}”>
click here for unsubscribe
</a>

In an embodiment, upon creating the mail template by including the placeholders and the attributes, the mail template may be uploaded into document personalization system 306. The uploaded mail template may be converted from HTML to Extensible Hyper Text markup language (XHTML) format and checked for anomalies (for e.g. as explained in detailed description of FIG. 3) Upon checking for such anomalies, warnings and errors may be generated, indicating incorrect placeholders' syntax, invalid HTML syntax, etc. The mail template may then be previewed. For example, the mail template may be previewed in a browser by instantiating the associated API. The associated API may include an event handler that may instantiate the browser to preview the mail template.

In an embodiment, document parsing module 308 parses the mail template to determine placeholders, objects and attributes. The XHTML mail template may be parsed into Extensible Markup Language (XML) document object model (DOM). The determination of the placeholders and the attributes may include determining corresponding XML nodes. In an embodiment, an instance of a class of function may be instantiated by a constructor. The constructor may be a class or a function with a subroutine to create an object of class. For example, a class ‘CL_TT_HTML_MERGE’ may be instantiated. The constructor of this class may receive the mail template as XHTML string The XHTML string includes the content of the mail template. The instantiation of class ‘CL_TT_HTML_MERGE’ may parse the mail template as XHTML string into the XML DOM to the determination of the attributes and the placeholders.

In an embodiment, upon such determination, document processing module 308 may instantiate supplant module 310. Supplant module 310 is configured to supplant the attributes with the corresponding attribute values. Supplant module 310 may instantiate, for example, a function of class ‘CL_TT_HTML_MERGE→REPLACE’ to supplant the attributes and placeholders by corresponding attribute values. In an embodiment, when the mail template includes extension data fields as placeholders, the instantiation of function or class ‘CL_TT_HTML_MERGE→REPLACE’ supplants the attributes with the corresponding attribute values.

In an embodiment, upon such instantiation, the class or function ‘CL_TT_HTML_MERGE→REPLACE’ transforms each placeholder into XML string and parses the XML string into corresponding XML DOM. For instance, the transformation of the XML string may be executed using Extensible Stylesheet Language (XSLT). The values corresponding to the attributes and the placeholders may be determined using XML Path Language (XPATH) in the XML DOM in the transformed placeholder instance. The placeholders and the attributes may be reused to create or generate multiple personalized emails. Such reusability optimizes the performance of the document personalization system 306 for generating or creating personalized emails.

In an embodiment, upon supplanting the attributes and the placeholders with their corresponding attribute values, document personalization system 306 generates a personalized mail. The personalized mail template may be delivered to a recipient by instantiating document delivery module 312. For instance, a class or function ‘CL_OM_EMAIL_REQUEST→SEND’ may be instantiated to send the personalized mail to the intended recipients.

In an embodiment, the HTML syntax for placeholders, conversion of the HTML mail template to XHTML, parsing of the XHTML mail template into XML DOM, creating and instantiating classes or functions for personalizing emails and sending the personalized emails are used for illustrative purposes.

In an embodiment, the document personalization system 306 may be configured to include additional data fields in the mail templates. Such a provision of including additional data fields provides extensibility by reusing of the data fields. The data fields may embed user defined content or attributes that may be personalized by document personalization system 306 at run time. In an embodiment, document personalization system 306 may be deployed at software layer of the cloud computing environment. The functionalities and services provided by document personalization system 306 at the software layer may be consumed by other applications deployed in the software layer in the cloud computing environment. For example, the software layer may be a central software layer in the cloud computing environment.

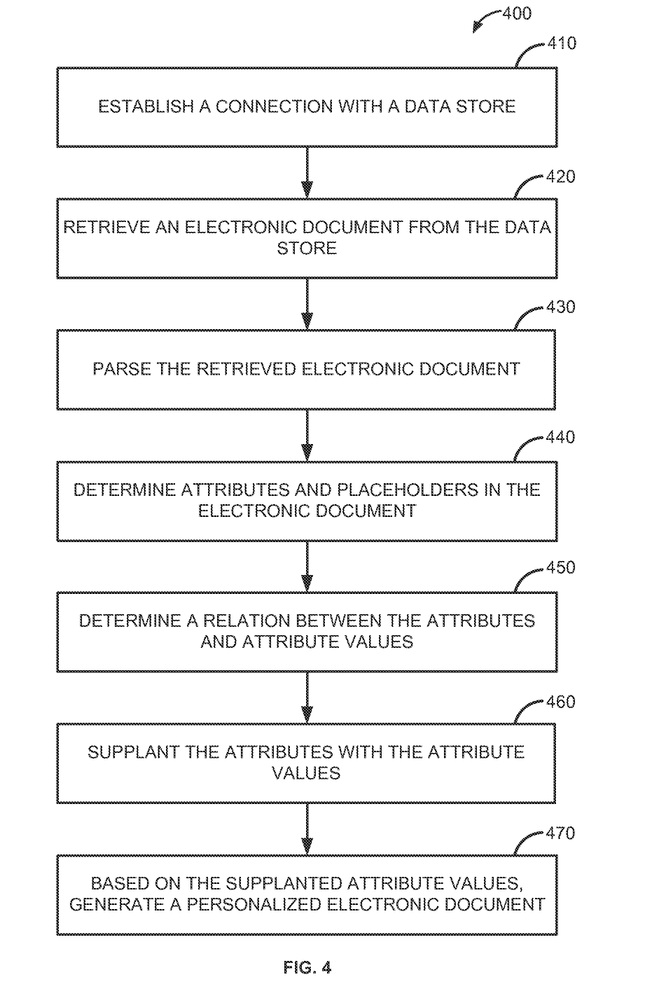

FIG. 4 is a flow diagram illustrating process 400 for generating a personalized electronic document, according to an embodiment. Upon execution, process 400 generates a personalized electronic document, for example, a personalized mail. In an embodiment, the data in the data store may include electronic documents, templates, static and dynamic digital content, such as, multimedia, animations, images, etc., personal data related to customers, etc. The personal data related to the customers may be stored in multiple tables in the data store.

In an embodiment, Table 1, residing in a data store, exemplarily illustrates personal data associated with the customers.

TABLE 1

| Object | First Name | Last Name | Designation | Department | Enterprise |
|---|---|---|---|---|---|
| OBJ 1 | John | Smith | Manager | Sales | SAP |
| OBJ 2 | Dwayne | Bravo | Supervisor | Marketing | Wal-Mart |
| OBJ 3 | Steve | Gates | Senior | Product | Caterpillar |
| | | | Manager | Engineering | |
| OBJ 4 | Merlin | Jobs | Senior | Sales | Wegnians |
| | | | Supervisor | | |
| OBJ 5 | Merissa | Mermaid | Manager | Support | Target |

The columns of Table 1 correspond to the attributes of the personal data including ‘First Name,’ ‘Last Name,’ ‘Designation,’ ‘Department,’ ‘Enterprise.’ The rows of Table 1 correspond to the attribute values of the personal data. For illustration, Table 1 includes the column ‘Object’ that includes a business object corresponding to each row and each business object storing a reference to the attributes and the associated attribute values. The business object may be referenced via an identifier. For example, OBJ 1 corresponds to a first instance of the attribute including attribute values ‘John,’ ‘Smith,’ ‘Manager,’ ‘Sales,’ and ‘SAP.’ OBJ 2 corresponds to a second instance of the attribute including attribute values ‘Dwayne,’ ‘Bravo,’ ‘Supervisor,’ ‘Marketing,’ and ‘Wal-Mart,’ and so on.

In an embodiment, Table 1 shows personal data corresponding to customers who have subscribed with a cell phone manufacturer to receive information on a new cell phone release. Such information may be stored in table in data store that may be owned by the cell phone manufacturer. ‘Bob’, who is employed with the marketing team of the cell phone manufacturer, is assigned a task to market the release of a new cell phone. ‘Bob’ may access the data store to get information on the list of customers who have subscribed to receive such information. ‘Bob’ may use document personalization application and create anew marketing campaign to disseminate information on the release of the new cell phone, ‘Bob’ creates the marketing campaign in document personalization system application including personal information of a target group of customers. For instance, the information related to target group of customers is exemplarily illustrated in Table 1.

In an embodiment, ‘Bob’ may use document design application to design a mail template that includes layouts for embedding content, such as, standard content, editable subject line, editable content, pictures, placeholders, attributes corresponding to personal data and the like. ‘Bob’ saves the mail template in data store. ‘Bob’ may access document personalization application via a user interface to personalize the mail template.

In an embodiment, ‘Bob’ uses the document personalization application, to establish a connection with the data store, at 410. Upon establishing connection, the mail template is retrieved from the data store, at 420. Upon retrieving the mail template, ‘Bob’ instantiates the execution of the marketing campaign. The execution of the marketing campaign includes personalizing the mail template by including corresponding personal data associated with the different customers (e.g. as explained in reference to FIG. 3), and sending the personalized mails to the customers.

In an embodiment, Table 2 exemplarily illustrates an electronic document, for example, a mail template designed using the document design application.

TABLE 2
Dear <First name Last name>, <Designation, Enterprise>
This is to inform you about a release of a new cell phone SAMLO
100 that our company SAMLO has released to the market recently.
The cell phone has been designed with features that are best adapted
to the <department> department.

The mail template of Table 2 is retrieved from the data store into document personalization application.

In an embodiment, the retrieved mail template is parsed, at 430. Document personalization application parses the mail template to check for anomalies. Upon such determination, the document personalization application determines placeholders and attributes, at 440. For example, in Table 2, the placeholders are <First Name Last Name>, <Designation, Enterprise>, and <department>.

Document personalization application determines the placeholders, and the attributes and the corresponding attribute values reference via the objects' identifier, at 450. A relation between the attributes and the attribute values is determined via the object identifier.

Based on the determined relations, one or more attributes are supplanted with one or more attribute values, at 460. For instance, when document personalization application references OBJ 1, supplant module of document personalization application supplants the attributes with the corresponding attribute values.

Based on the supplanted attribute values, the mail template is personalized to generate a personalized electronic document, at 470.

In an embodiment, Table 3 exemplarily illustrates a supplanted mail template for OBJ 1, using document personalization application.

TABLE 3
Dear John Smith , Manager, SAP
This is to inform you about on a release of a new cell phone SAMLO
100 that our company SAMLO has released to the market recently.
The cell phone has been designed with features that are best adapted
to the Sales department.

Table 3 exemplarily illustrates a personalized mail template corresponding to OBJ 1. As exemplarily illustrated, the attributes corresponding to ‘First Name,’ ‘Last Name,’ ‘Designation,’ and ‘department’ is respectively supplanted with the attribute values ‘John,’ ‘Smith,’ ‘Manager,’ ‘SAP,’ and ‘Sales.’ Hence the mail template is personalized with the personalization data and a personalized mail is generated.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Sonic example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be anon-transitory computer readable storage medium. Examples of anon-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

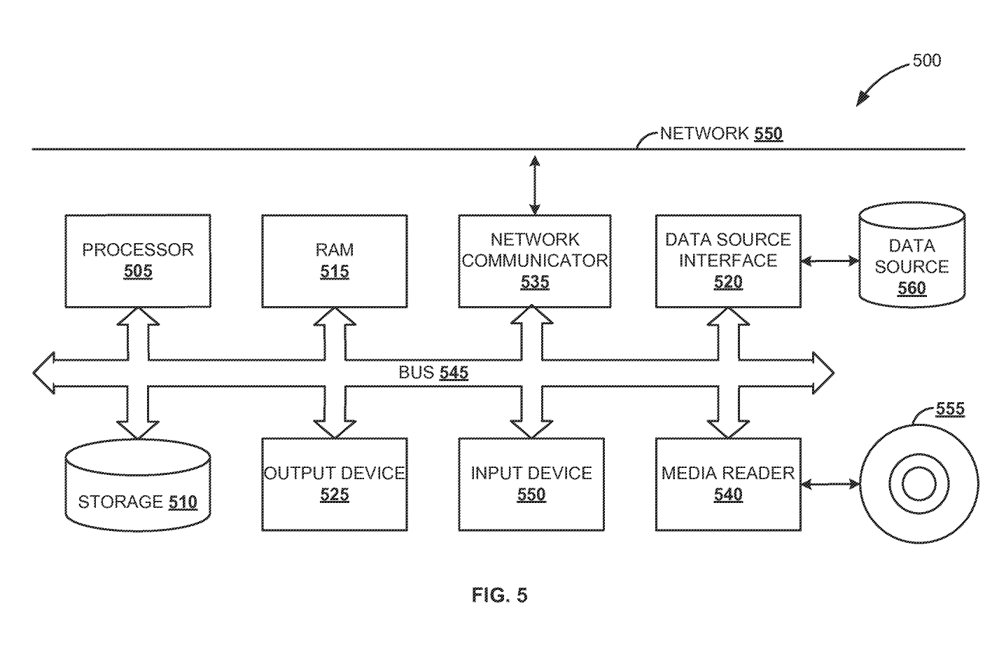

FIG. 5 is a block diagram of an exemplary computer system 500, according to an embodiment. Computer system 500 includes processor 505 that executes software instructions or code stored on computer readable storage medium 555 to perform the above-illustrated methods. Processor 505 can include a plurality of cores. Computer system 500 includes media reader 540 to read the instructions from computer readable storage medium 555 and store the instructions in storage 510 or in random access memory (RAM) 515. Storage 510 provides a large space for keeping static data where at least some instructions could be stored for later execution. According to some embodiments, such as some in-memory computing system embodiments, RAM 515 can have sufficient storage capacity to store much of the data required for processing in RAM 515 instead of in storage 510. In some embodiments, all of the data required for processing may be stored in RAM 515. The stored instructions may be further compiled to generate other representations of the instructions and dynamically stored in RAM 515. Processor 505 reads instructions from RAM 515 and performs actions as instructed. According to one embodiment, computer system 500 further includes output device 525 (e.g., a display) to provide at least some of the results of the execution as output including, but not limited to, visual information to users and input device 530 to provide a user or another device with means for entering data and/or otherwise interact with computer system 500. Each of these output devices 525 and input devices 530 could be joined by one or more additional peripherals to further expand the capabilities of computer system 500. Network communicator 535 may be provided to connect computer system 500 to network 550 and in turn to other devices connected to network 550 including other clients, servers, data stores, and interfaces, for instance. The modules of computer system 500 are interconnected via bus 545. Computer system 500 includes a data source interface 520 to access data source 560. Data source 560 can be accessed via one or more abstraction layers implemented in hardware or software. For example, data source 560 may be accessed by network 550. In some embodiments data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications arc possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to generate a personalized electronic document, comprising:
based on a connection established with a data store, retrieving, by a cloud-based document personalization application, an electronic document from the data store; and
triggering the cloud-based document personalization application to personalize the electronic document by:
parsing the retrieved electronic document to determine one or more placeholders and one or more attributes, the attributes associated with personalization data residing in the data store;
determining a relation between the one or more attributes and one or more attribute values; and
supplanting the determined one or more attributes with the one or more attribute values corresponding to the personalization data; and
based on the supplanted attribute values, generating a personalized electronic document.

2. The computer implemented method of claim 1, further comprising: one or more objects representing one or more instances of the attribute values corresponding to the personalization data.

3. The computer implemented method of claim 1, further comprising: parsing the electronic document to: check for one or more anomalies including: invalid HTML code, one or more incorrect placeholders, and presence of one or more computer contaminants.

4. The computer implemented method of claim 1, wherein the supplanting comprises; substituting the one or more attributes with the corresponding one or more attribute values in the placeholders.

5. The computer implemented method of claim 1, further comprising: configuring a document design application to design the electronic document including one or more layouts and one or more data fields for embedding content corresponding to one or more placeholders, the one or more attributes, a subject line content, and a standard content.

6. The computer implemented method of claim 1, further comprising configuring the electronic document to include one or more extension data fields for providing extensibility of the electronic document.

7. The computer implemented method of claim 1, further comprising: executing one or more rules for embedding supplementary content in the personalized electronic document.

8. A computer system to generate a personalized electronic document, comprising:
a processor operable to read and execute instructions stored in one or more memory elements;
a data store including one or more electronic documents, one or more templates, and personalization data associated with one or more customers;
a document delivery module configured to establish a connection with the data store and retrieve an electronic document;
a document processing module configured to: parse the retrieved electronic document to determine one or more placeholders, and one or more attributes, the attributes associated with personalization data residing in the data store;
a supplanting module configured to:
determine a relation between the one or more attributes and one or more attribute values; and
supplant the determined one or more attributes with the one or more attribute values corresponding to the personalization data; and
based on the supplanted attribute values, generating a personalized electronic document.

9. The computer system of claim 8, wherein the supplanting module executes the supplanting by replacing the one or more attributes with the corresponding one or more attribute values in the placeholders.

10. The computer system of claim 8, wherein the document processing module is configured to parse the electronic document to check for one or more anomalies including: invalid HTML code, one or more incorrect placeholders, and presence of one or more computer contaminants.

11. The computer system of claim 8, wherein the supplant module is configured, with one or more rules, to determine embedding supplementary content in the personalized document.

12. The computer system of claim 8, wherein the document delivery module is configured to perform a test send of the personalized document to a pre-determined e-mail address.

13. A non-transitory computer readable storage medium tangibly storing instructions, which when executed by a computer, cause the computer to execute operations comprising:
based on a connection established with a data store, re eve by a cloud-based document personalization application, an electronic document from the data store; and
trigger the cloud-based document personalization application to personalize the electronic document by:
parse the retrieved electronic document to determine one or more placeholders, and one or more attributes, the attributes associated with personalization data residing in the data store;
determine a relation between the one or more attributes and one or more attribute values; and
supplant the determined one or more attributes with the one or more attribute values corresponding to the personalization data; and
based on the supplanted attribute values, generate a personalized electronic document.

14. The non-transitory computer readable storage medium of claim 13 storing instructions, which when executed by the computer, cause the computer to execute operations further comprising:
parse the electronic document to check for one or more anomalies including: invalid HTML code, one or more incorrect placeholders, and presence of one or more computer contaminants.

15. The non-transitory computer readable storage medium of claim 13, wherein the supplanting comprises:
replacing the one or more attributes with the corresponding one or more attribute values in the placeholders.

16. The non-transitory computer readable storage medium of claim 13 storing instructions, which when executed by the computer, cause the computer to execute operations further comprising:
configure a document design application to design the electronic document including one or more layouts, and one or more data fields for embedding content corresponding to one or more of the one or more placeholders, the one or more attributes, a subject line content, and a standard content.

17. The non-transitory computer readable storage medium of claim 13 storing instructions, which when executed by the computer, cause the computer to execute operations further comprising:
configure the electronic document to include one or more extension data fields for providing extensibility of the electronic document.

18. The non-transitory computer readable storage medium of claim 13 storing instructions, which when executed by the computer, cause the computer to execute operations further comprising:
prompt a user to enter content into a subject line of the personalized electronic document.

19. The non-transitory computer readable storage medium of claim 13 storing instructions, which when executed by the computer, cause the computer to execute operations further comprising:
execute one or more rules for embedding supplementary content in the personalized electronic document.

20. The non-transitory computer readable storage medium of claim 13 storing instructions, which when executed by the computer, cause the computer to execute operations further comprising:
execute a lest send to send the personalized document to a pre-determined e-mail address.
